(19) United States
(12) Patent Application Publication
(10) Pub. No.: US 2021/0063151 A1
(43) Pub. Date: Mar. 4, 2021

(54) PRAYEROMETER

(71) Applicant: Jeff Bernard, San Diego, CA (US)

(72) Inventor: Jeff Bernard, San Diego, CA (US)

(21) Appl. No.: 16/660,049

(22) Filed: Oct. 22, 2019

Related U.S. Application Data
(60) Provisional application No. 62/893,783, filed on Aug. 29, 2019.

(51) Int. Cl. G01C 9/12; A47G 33/00; G01B 3/56

(52) U.S. Cl. CPC G01C 9/12; G01B 3/56; A47G 33/008

(57) ABSTRACT

A roll-indicating device links, for example, devotional prayers and degrees of travel/movement from a plane defining a horizontal axis and gravity pulling upon an indicator, preferably a cross.

### CROSS REFERENCE TO RELATED APPLICATIONS

This application claims the benefit of, and priority to U.S. Provisional Patent Application Ser. No. 62/893,783, filed Aug. 29, 2019, the content of which is incorporated herein by reference herein in its entirety.

### OBJECTS AND SUMMARY OF THE DISCLOSURES

Briefly stated, a roll-indicating device links, for example, devotional prayers and degrees of travel/movement from a plane defining a horizontal axis and gravity pulling upon an indicator, preferably a cross, via a display means for linking prayers to the degree of roll and so indicating in colorful and informative fashion, for use during travel.

According to embodiments, the PRAYEROMETER is a device using gravity to measure the roll of a ship/boat/plane/helicopter while designating a Christian prayer to the degree and severity of the roll. This device has devotional, humorous and serious components as sailing and flying can be very precarious as well as pleasurable experiences. The pleasant, humorous and serious components of the PRAYEROMETER combine to make a very effective novelty item for Christians who have sailed on the water and flown in the sky and want to measure the rolls their ship/boat/plane/helicopter takes while maintaining a prayerful, faithful disposition. The Prayerometer can also be used in spaceships and submarines.

A one hundred and eighty degree half circle is divided per twenty degrees. The word PRAYEROMETER is printed in capital letters at the top of a cardboard or wooden flat surface. A push pin, nail or whatever device is deemed best is attached at the center point of the “O” in the word PRAYEROMETER. A metal chain is attached to the push pin/nail with a weight best for measuring the degrees of a ship's/boat's/plane's/helicopter's rolls. A pendant cross is attached to the chain and suspended to hang within the half circle. The measurements and weight of the cross and half circle will be in keeping with the laws of physics such that the cross and half circle will align to measure the rolls a ship/boat/plane/helicopter takes. When a ship/boat/plane/helicopter experiences a roll, the cross measures the rolls in terms of degrees and points to a prayer matching to the degree of the roll. Working as a devotion, a person may pray the designated prayer listed within the degree section. The degree sections are color coded corresponding to the severity of the roll. The color codes correspond to human emotions ranging from cool to hot colors. The prayers assigned to the colors also correspond to the severity of the roll. The “Mariner's Prayer” can be substituted with the “Aviator's Prayer” for those who fly in planes, helicopters or spaceships. Also, the pendant cross and chain can be detached from the PRAYEROMETER and can be worn around the neck.

### BRIEF DESCRIPTION OF THE DRAWINGS

Various preferred embodiments are described herein with references to the drawings in which merely illustrative views are offered for consideration, whereby:

FIG. 1 is a schematic or cartooned depiction of an embodiment of the present invention having a specific type of cross;

FIG. 2 is a schematic or cartooned depiction of an embodiment of the present invention having a specific type of cross;

FIG. 3 is a schematic or cartooned depiction of an embodiment of the present invention having a specific type of cross;

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

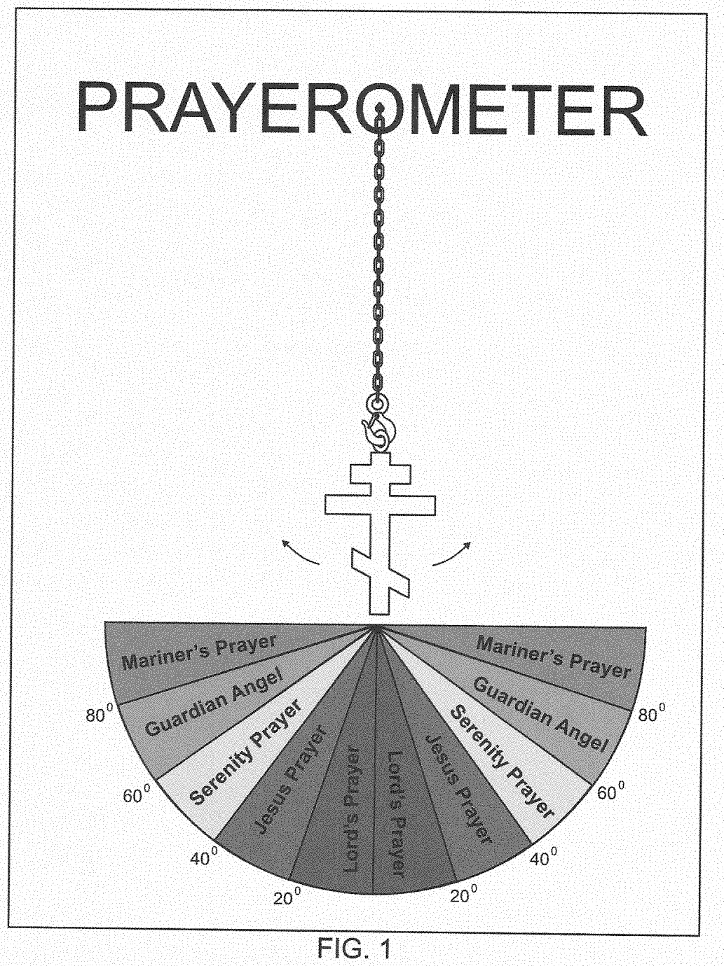

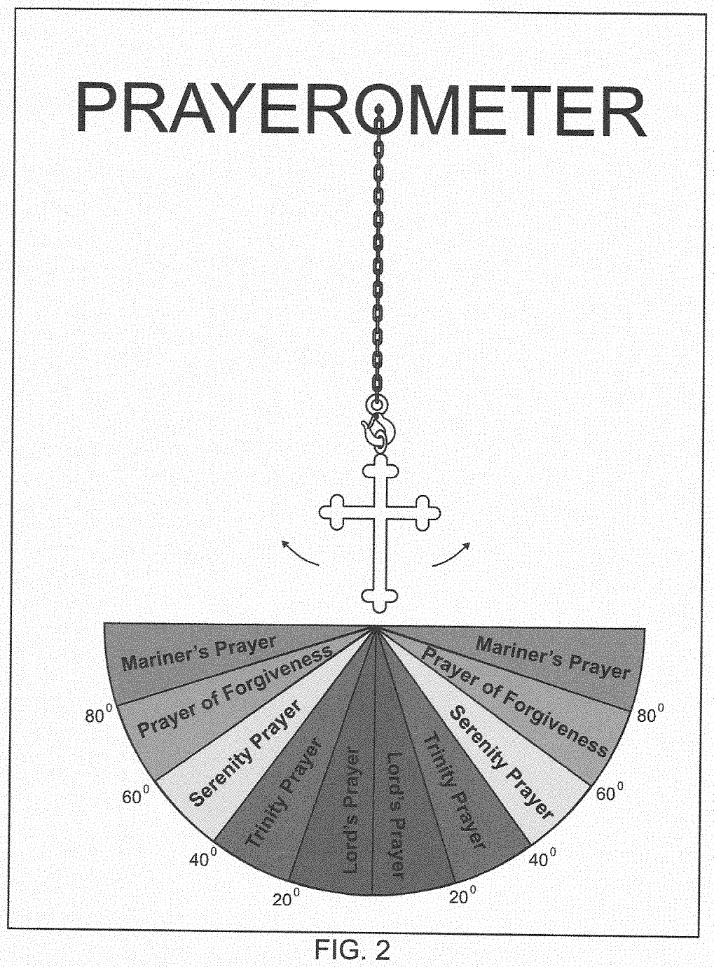

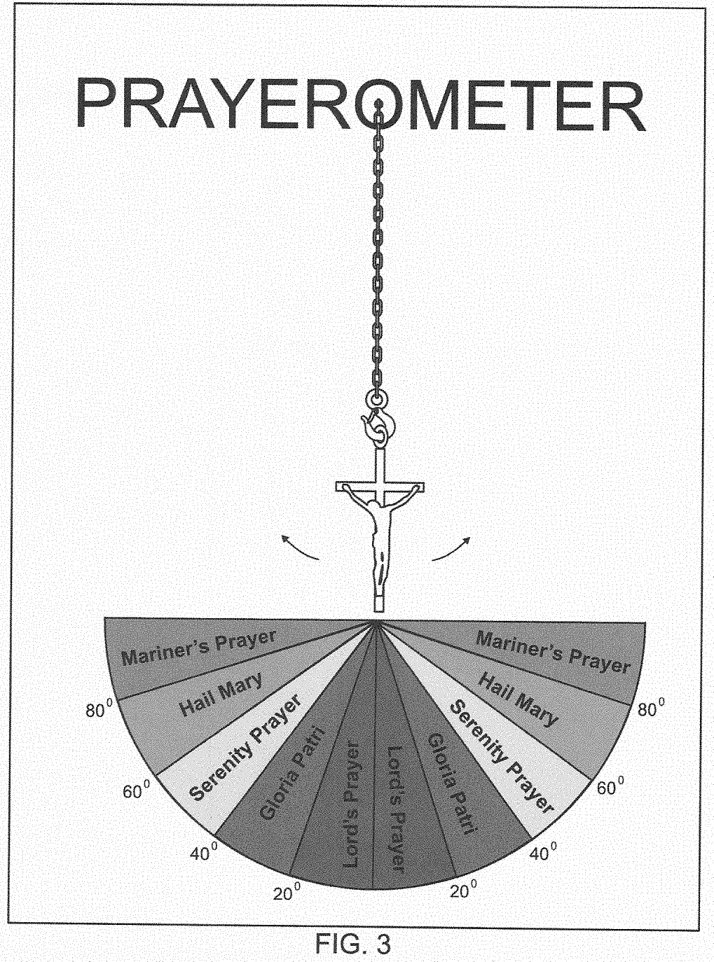

Referring now to FIG. 1-FIG. 3, at least 5 prayers are shown in prospective relation to the subject cross. Artisans understand the number, color and location to be interchangeable.

### DETAILED DESCRIPTIONS

The present inventor has coupled a roll detection system with highly symbolic spiritual symbols and indicia indicating “roll” or the movement side to side of an object having a longitudinal axis parallel to a direction of travel.

The PRAYEROMETER comes in three forms corresponding to the generalized denominations of Protestant, Roman Catholic and Eastern Orthodox. The Crosses will also correspond to the general denominations: a Latin Cross for Protestant, a Crucifix for Catholic and an Eastern Orthodox for Eastern Orthodox. The prayers will be printed on the back of the device as well as on paper cards which the customer can place according to his/her desire. The PRAYEROMETER will include hanging sticky tape on the back which will be strong enough to hold the PRAYEROMETER in place on any bulkhead. The PRAYEROMETER can be translated into many different languages according to demand.

It is respectfully submitted that one can say from experience the PRAYEROMETER is very effective as a devotion. Even though one need not make or pray the prayers oneself, it helped keep one in a faithful/prayerful frame of mind in either case. The PRAYEROMETER is also quite hypnotic. One can remember sitting alone watching the cross seemingly move on its own pointing to prayers and keeping oneself and companions in a pleasurable prayerful/hypnotic state. The PRAYEROMETER also has a humorous side. One remembers sitting with Sailors and laughing at the movement of the cross moving on its own volition. We simultaneously hoped and did not hope it would move into the yellow and orange sections, indicating the relative degree of Roll.

It is respectfully proposed and firmly believed that the PRAYEROMETER can sell in large quantities to a multitude of Christian men and women across the globe, along with any other who may be interested and/or have alternate schemata to manifest.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. Tt is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language mans that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom H X2, Intel Core Duo, AMD Phenom II X4, Intel Core i5, Intel Core I & Extreme Edition 980X, or Intel Xeon E7-2820).

An I/O mechanism may include a video display unit (e.g., a liquid crystal display (LCD) or a cathode my tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. Devices for measuring the roll of a moving vehicle, vessel or other transport means, having a central longitudinal access parallel to a direction of travel which comprises, in combination:
at least a pendant/means for demonstrating travel from a plane orthogonal to a half-circle which has movement during travel of said vehicle, measured in increments and designating devotional prayers by relative location; and
at least a cross attached to the pendant completing the demonstration of relative travel by indicating a location of the cross on the half-circle in front of which a terminal end is disposed, along with indicia marking different zones linked to prayer, symbols and the like.

2. Devices of claim 1, further comprising:
attachment means and ballast weighting of said cross whereby alignment of said cross with designated devotional prayer changes along with measured roll of said vehicle, not pitch and yaw.

3. Devices of claim 1, 2 and as shown and described whereby color coding likewise indicates the relative severity of the roll being measured, and provides concomitant spiritual guidance via, for example devotional prayers listed.

4. Devices of claims 1-3, and as shown and described attached within a circular letter “O” from which said pendant dangles, optionally emplaced within PRAYEROMETER or proximate thereto.

5. Devices of claims 1-4 and as shown and described and embodied in the listed and shown elements, following a Christian theme, each said element being modular or detachable so as to be interchangeable.

6. Crosses, according to all previous claims and the appendices and figures hereof, as shown and described for indicating rotation about an axis running from a front to rear and of a traveling vehicle or transport, which is parallel to the horizon.

7. Systems for measuring roll in moving objects having a central longitudinal access parallel to a direction of travel having alternate themes, colors and spiritual groundings, according to any of the claims figures or appendices herein, and/or implemented digitally or electronically.

8. Systems according to any claims herein, further comprising at least a Latin Cross for Protestants, a Crucifix for Catholics and an Eastern Orthodox for Eastern Orthodox followers whereby, prayers are printed on the back of the devices as well as on paper cards which the customer can place according to his/her desire; optionally said PRAYEROMETER includes for example, hanging sticky tape on the back which will be strong enough to hold the PRAYEROMETER in place on any bulkhead, and said PRAYEROMETER can be translated into many different languages according to demand, including braille and other symbolic symbol and digital reference character strings.
